(19) United States
(12) Patent Application Publication
(10) Pub. No.: US 2025/0209913 A1
(43) Pub. Date: Jun. 26, 2025

(54) INFORMATION PROCESSING APPARATUS, CONTROL TERMINAL, INFORMATION PROCESSING METHOD, AND NON-TRANSITORY COMPUTER-READABLE STORAGE MEDIUM STORING A COMPUTER PROGRAM

(71) Applicant: Sumitomo Electric Industries, Ltd., Osaka-shi, Osaka (JP)

(72) Inventors: Shintaro MATSUMOTO, Osaka-shi, Osaka (JP); Toshiya YOSHIOKA, Osaka-shi, Osaka (JP); Shigeki NISHIMURA, Osaka-shi, Osaka (JP)

(73) Assignee: Sumitomo Electric Industries, Ltd., Osaka-shi, Osaka (JP)

(21) Appl. No.: 18/851,726

(22) PCT Filed: Dec. 28, 2022
(86) PCT No.: PCT/JP2022/048621

§ 371 Date: Sep. 27, 2024

(30) Foreign Application Priority Data
Mar. 28, 2022 (JP) 2022-051635

(51) Int. Cl. G08G 1/081; G08G 1/01

(52) U.S. Cl. CPC G08G 1/081; G08G 1/0125

(57) ABSTRACT

An information processing apparatus includes an acquisition circuit configured to acquire probe information of a probe vehicle passing through an inflow pass leading to an intersection, and a control circuit configured to execute dynamic control of determining, for each of predetermined control periods, a signal control parameter to be applied to the intersection. The intersection is an intersection not subjected to remote control by a central apparatus, the signal control parameter includes a split to be applied to the intersection, and the dynamic control includes split dynamic control of updating the split in accordance with a traffic indicator of the inflow pass, the traffic indicator being calculated from the probe information.

### TECHNICAL FIELD

The present disclosure relates to an information processing apparatus, a control terminal, an information processing method, and a computer program. This application claims priority based on Japanese Patent Application No. 2022-51635 filed on Mar. 28, 2022, and the entire contents of the Japanese patent application are incorporated herein by reference.

### BACKGROUND ART

Patent literature 1 describes a device for calculating a traffic indicator required for calculating a signal control parameter. The calculation device includes a first calculation unit that calculates normalized data representing a ratio of a traffic variable of an inflow pass of a target intersection to a saturation traffic flow rate, and a second calculation unit that calculates a traffic indicator defined by an expression in which the traffic variable of the inflow pass is included in a numerator and the saturation traffic flow rate is included in a denominator, using the normalized data.

The first calculation unit calculates the normalized data using, for example, the delay time due to the signal waiting obtained from the probe information of the vehicle.

### CITATION LIST

### Patent Literature

Patent literature 1: WO 2020/071040

### SUMMARY OF THE INVENTION

An apparatus according to an aspect of the present disclosure is an information processing apparatus that includes an acquisition unit configured to acquire probe information of a probe vehicle passing through an inflow pass leading to an intersection, and a control unit configured to execute dynamic control of determining, for each of predetermined control periods, a signal control parameter to be applied to the intersection. The intersection is an intersection not subjected to remote control by a central apparatus, the signal control parameter includes a split to be applied to the intersection, and the dynamic control includes split dynamic control of updating the split in accordance with a traffic indicator of the inflow pass, the traffic indicator being calculated from the probe information.

An apparatus according to another aspect of the present disclosure is a control terminal connected to a traffic signal controller of an intersection not subjected to remote control by a central apparatus. The control terminal includes a communication unit configured to receive probe information of a probe vehicle passing through an inflow pass leading to the intersection, and a control unit configured to execute dynamic control of determining, for each of predetermined control periods, a signal control parameter to be applied to the intersection. The signal control parameter includes a split to be applied to the intersection, and the dynamic control includes split dynamic control of updating the split in accordance with a traffic indicator of the inflow pass, the traffic indicator being calculated from the probe information.

A method according to an aspect of the present disclosure is an information processing method that includes acquiring probe information of a probe vehicle passing through an inflow pass leading to an intersection, and executing dynamic control of determining, for each of predetermined control periods, a signal control parameter to be applied to the intersection. The intersection is an intersection not subjected to remote control by a central apparatus, the signal control parameter includes a split to be applied to the intersection, and the dynamic control includes split dynamic control of updating the split in accordance with a traffic indicator of the inflow pass, the traffic indicator being calculated from the probe information.

A computer program according to an aspect of the present disclosure is a computer program for causing a computer to function as an information processing apparatus that includes an acquisition unit configured to acquire probe information of a probe vehicle passing through an inflow pass leading to an intersection, and a control unit configured to execute dynamic control of determining, for each of predetermined control periods, a signal control parameter to be applied to the intersection. The intersection is an intersection not subjected to remote control by a central apparatus, the signal control parameter includes a split to be applied to the intersection, and the dynamic control includes split dynamic control of updating the split in accordance with a traffic indicator of the inflow pass, the traffic indicator being calculated from the probe information.

The present disclosure can be implemented not only as a system and an apparatus having the characteristic configuration as described above, but also as a program for causing a computer to execute the characteristic configuration. Further, the present disclosure can be implemented as a semiconductor integrated circuit that implements a part or all of the system and the apparatus.

### BRIEF DESCRIPTION OF THE DRAWINGS

FIG. 1 is a diagram showing an overall configuration of a traffic signal control system.

FIG. 2 is a block diagram of a server, a vehicle-mounted apparatus of a probe vehicle, a central apparatus, and a control terminal included in a traffic signal control system.

FIG. 3 is an explanatory diagram showing an example of an installation state of a control terminal.

FIG. 4 is an explanatory diagram showing an example of state transition of dynamic control of split.

FIG. 5 is a flowchart showing an example of information processing for dynamic control of split.

FIG. 6 is an explanatory diagram showing an example of state transition of dynamic control of offset.

FIG. 7 is a flowchart showing an example of information processing for dynamic control of offset.

FIG. 8 is an explanatory diagram of an average travel time of a wait-for-signal-to-change section in an inflow pass.

FIG. 9 is an explanatory diagram showing a definition of variables included in a calculation formula of an average travel time of a wait-for-signal-to-change section.

FIG. 10 is a flowchart showing an example of a calculation processing of a total number of sections in a wait-for-signal-to-change section.

FIG. 11 is an explanatory diagram showing an example of actual calculation of a total number of sections.

### DETAILED DESCRIPTION

### Problems to be Solved by the Present Disclosure

An intersection where the periodic control is performed because the vehicle sensor is not installed (so-called standalone intersection) is not subjected to the remote control by the central apparatus. In such a standalone intersection, even when the signal control parameter is calculated in accordance with the traffic indicator calculated from the probe information, manual operation is indispensable for actually operating the traffic signal controller with the parameter. Further, it takes effort to cope with the secular change of the traffic situation after the introduction of the parameter.

The present disclosure aims to enable simplified control of intersections that are not subjected to remote control by a central device, in view of the above problems.

### Effects of Present Disclosure

According to the present disclosure, it is possible to easily control an intersection which is not subjected to remote control by a central apparatus.

### Outline of Embodiments of Present Disclosure

Hereinafter, the outline of the embodiments of the present disclosure will be listed and described.

(1) An apparatus according to an aspect of the present disclosure is an information processing apparatus that includes an acquisition unit configured to acquire probe information of a probe vehicle passing through an inflow pass leading to an intersection, and a control unit configured to execute dynamic control of determining, for each of predetermined control periods, a signal control parameter to be applied to the intersection. The intersection is an intersection not subjected to remote control by a central apparatus, the signal control parameter includes a split to be applied to the intersection, and the dynamic control includes split dynamic control of updating the split in accordance with a traffic indicator of the inflow pass, the traffic indicator being calculated from the probe information.

According to the information processing apparatus of the embodiment, since the dynamic control executed by the control unit includes the dynamic control of the split, the split of the intersection which is not subjected to the remote control by the central apparatus can be updated without manual operation. Thus, the intersection which is not subjected to the remote control by the central apparatus can be easily controlled.

(2) In the information processing apparatus of the embodiment, in a case where the traffic indicator of the inflow pass includes a first traffic indicator from which saturation of the inflow pass is determinable, the control unit may be configured to increase a split of the inflow pass on a condition that saturation of the inflow pass has been detected in accordance with the first traffic indicator.

In this way, the possibility that saturation of the inflow pass is canceled is increased, and the traffic situation of the intersection can be improved.

(3) In the information processing apparatus of the embodiment, the condition for increasing the split of the inflow pass may further include that any inflow pass other than the inflow pass is not saturated.

In this way, it is possible to handle the reduction of saturation of each inflow pass fairly, in addition to the reduction of splits of other inflow passes.

(4) In the information processing apparatus of the embodiment, the control unit may be configured to decrease the increased split of the inflow pass on a condition that a tendency of the detected saturation to be relieved has been detected.

In this way, the split of the inflow pass that has been increased once can be appropriately returned to the original split.

(5) In the information processing apparatus of the embodiment, the control unit may be configured to decrease the increased split of the inflow pass on a condition that any inflow pass other than the inflow pass has turned to saturation.

In this way, the reduction of the over-saturation of each inflow pass can be executed fairly.

(6) In the information processing apparatus of the embodiment, when the saturation of the inflow pass is over-saturation of the inflow pass, at least one of an average travel time in a wait-for-signal-to-change section of the inflow pass, a delay time per vehicle in the wait-for-signal-to-change section of the inflow pass, or a queue length in the wait-for-signal-to-change section of the inflow pass can be adopted as the first traffic indicator.

Since these traffic indicators are traffic indicators related to the wait-for-signal-to-change section of the inflow pass, it is possible to accurately detect over-saturation in the inflow pass compared to a case where the average travel time of the link that is likely to include a stop event other than signal waiting is adopted, for example.

(7) In the information processing apparatus of the embodiment, the saturation of the inflow pass may be near-saturation of the inflow pass, and in this case, as the first traffic indicator, a demand rate of the inflow pass can be adopted.

As described above, adopting near-saturation as the traffic situation indicating saturation of the inflow pass can increase the split of the inflow pass before the saturation becomes over-saturation. Thus, over-saturation can be prevented or reduced.

(8) In the information processing apparatus of the embodiment, the signal control parameter may include an offset to be applied to the intersection and an intersection on an upstream side of the intersection, and the dynamic control may include offset dynamic control of updating the offset in accordance with the traffic indicator of the inflow pass, the traffic indicator being calculated from the probe information.

According to the information processing apparatus of the embodiment, since the dynamic control executed by the control unit includes the dynamic control of the offset, the offset of the intersection which is not subjected to the remote control by the central apparatus can be updated without manual operation. Thus, the intersection which is not subjected to the remote control by the central apparatus can be controlled more easily.

(9) In the information processing apparatus of the embodiment, when the traffic indicator of the inflow pass includes a second traffic indicator from which whether the intersection on the upstream side has queue spillback is determinable, the control unit may adopt an offset of delaying a cycle of the intersection on the upstream side in response to detecting the queue spillback in accordance with the second traffic indicator.

In this way, the possibility that the queue spillback of the inflow pass is canceled is increased, and the traffic situation of the intersection can be improved.

(10) In the information processing apparatus of the embodiment, the second traffic indicator can adopt at least one of a queue length in a wait-for-signal-to-change section of the inflow pass or an end position of the wait-for-signal-to-change section of the inflow pass, the end position being specified based on image data captured by the probe vehicle.

By adopting these traffic indicators, the queue spillback at the intersection on the upstream side can be accurately detected.

(11) In the information processing apparatus of the embodiment, the control unit may be configured to, when the probe information acquired in a current control period has an insufficient number of pieces of data, execute the dynamic control by using complementary probe information set in advance.

In this way, even when the pieces of data of the probe information are not sufficient, the signal control parameters such as split and offset can be appropriately updated.

(12) An apparatus according to another aspect of the present disclosure is a control terminal connected to a traffic signal controller of an intersection not subjected to remote control by a central apparatus. The control terminal includes a communication unit configured to receive probe information of a probe vehicle passing through an inflow pass leading to the intersection, and a control unit configured to execute dynamic control of determining, for each of predetermined control periods, a signal control parameter to be applied to the intersection. The signal control parameter includes a split to be applied to the intersection, and the dynamic control includes split dynamic control of updating the split in accordance with a traffic indicator of the inflow pass, the traffic indicator being calculated from the probe information.

According to the control terminal of the embodiment, since the dynamic control executed by the control unit includes the dynamic control of the split, the split of the intersection which is not subjected to the remote control by the central apparatus can be updated without manual operation. Thus, the intersection which is not subjected to the remote control by the central apparatus can be easily controlled.

(13) A method according to an aspect of the embodiment is an information processing method executed by the information processing apparatus according to any one of (1) to (11). Thus, the information processing method of the embodiment achieves the same operations and effects as the information processing apparatus of the above (1) to (11).

(14) A computer program according to an aspect of the embodiment is a computer program for causing a computer to function as the information processing apparatus according to any one of (1) to (11). Thus, the computer program of the embodiment of the present disclosure achieves the same operations and effects as the information processing apparatus of the above (1) to (11).

### DETAILS OF EMBODIMENTS OF THE INVENTION

Hereinafter, embodiments of the present invention will be described in detail with reference to the drawings. At least a part of the embodiments described below may be arbitrarily combined.

### Definition of Terms

Before describing the details of the embodiments, the terms used in this specification will be defined.

“Vehicle”: Refers to all types of vehicles traveling on the road in general. Thus, in addition to automobiles, small cars, and trolley buses, motorcycles also correspond to vehicles. The vehicle drive system is not limited to an internal combustion engine, and electric vehicles and hybrid vehicles are also included in the vehicle. In the embodiment, when simply referred to as “vehicle”, it includes both a probe vehicle having a vehicle-mounted apparatus capable of transmitting probe information and a normal vehicle that does not provide probe information to the outside.

“Probe information”: Refers to various information about the vehicle sensed by a probe vehicle traveling on the road. The probe information is also referred to as probe data or floating car data. The probe information can include identification information of the probe vehicle, and vehicle data such as a vehicle position, a vehicle speed, a traveling direction, and times of occurrence of these. Information such as position and acceleration acquired by a smartphone, a tablet, or the like in the vehicle may be used as the probe information.

“Probe vehicle”: Refers to a vehicle that senses probe information and transmits the probe information to the outside. The vehicles traveling on the road include both the probe vehicle and other vehicles. However, even in a case of a normal vehicle that does not include a vehicle-mounted apparatus capable of transmitting probe information, a vehicle that includes a smartphone, a tablet PC, or the like as described above and that can transmit probe information such as position information of the vehicle to the outside is included in the probe vehicle.

“Signal control parameter”: The cycle length, split, and offset, which are time elements of signal indication, are collectively referred to as a signal control parameter. This is also referred to as a signal control constant.

“Cycle length”: Refers to the period of time from the start of the green (or red) signal of a traffic signal to the start of the next green (or red) signal, constituting one complete cycle. In addition, in Japan, it is regulated by law that signal light colors that actually appear green be called blue.

“Split”: Refers to the ratio of a length of time of the duration assigned to each indication in relation to the cycle length. Generally, it is expressed as a percentage or a ratio. Strictly speaking, it is a value obtained by dividing the effective green signal time by the cycle length. “Offset”: In system control or regional control, the offset is a deviation of a certain point in time of signal indication, for example, a start point in time of a main road's green light, from a reference point in time common to the group of signals, or a deviation of the start points of the same indication between adjacent intersections. The former is referred to as an absolute offset, and the latter is referred to as a relative offset, which is expressed by time (second) or a percentage in a cycle.

“Green signal time”: Refers to the period of time at an intersection during which vehicles are in a right-of-way state. The end time of the blue signal time may be set to the point in time at which the green light is turned off at the earliest, or to the point in time at which the yellow light is turned off at the latest. In the case of an intersection with an arrow light, the end time may be the point in time at the end of the turn-right arrow. “Red signal time”: Refers to the period of time at an intersection during which vehicles do not have a right-of-way. The start time of the red signal time may be set to the point of time at which the green light is turned off at the earliest, or the point of time at which the yellow light is turned off at the latest. In the case of an intersection with an arrow light, the start time may be the point in time at the end of the turn-right arrow.

As described above, in the embodiment of the present disclosure, the time periods included in one cycle are roughly divided into the green signal time with right-of-way and the red signal time without right-of-way. Thus, when the green signal time is G, the red signal time is R, and the cycle length is C, the relationship of C=G+R is established. Thus, in the following description, R may be read as (C−G). That is, red signal time R may be a value indirectly calculated from cycle length C and green signal time G.

“Queue”: Refers to the line of vehicles that have come to a stop before an intersection due to factors such as waiting for a red signal. The length (m) of the queue is referred to as “queue length”. “Link”: Refers to a road section that connects nodes such as intersections, with an upward direction or a downward direction. It is also called a road link. A link in a direction of inflow toward an intersection when viewed from the intersection is referred to as an inflow link, and a link in a direction of outflow from the intersection when viewed from the intersection is referred to as an outflow link.

“Travel time”: Refers to the time taken for a vehicle to travel through a certain section. The travel time may include a stop time and a delay time on the way. “Link travel time”: Refers to the travel time when the unit of the road section for calculating the travel time is a “link”, that is, travel time required for the vehicle to travel from the start point to the end point of one link.

“Traffic volume”: Refers to the number of vehicles passing through in a given period of time. Unless otherwise specified, the traffic volume is represented by the number of passing vehicles per hour, but for control or evaluation, a traffic volume for a short time, for example, in units of seconds, 5 minutes, or 15 minutes may be used. Generally, the traffic volume increases in accordance with the traffic demand, but decreases when the traffic demand exceeds the traffic capacity.

“Over-saturation/non-saturated/near-saturation”: When the signal queue is left unsettled at the end of the green indication, the traffic demand exceeds the traffic capacity. This state is referred to as an “over-saturation state”. On the other hand, a state in which the traffic demand is equal to or less than the traffic capacity and the signal queue is cancelled at the end of the green indication is referred to as a “non-saturated state”. A state in which the demand rate is high (for example, a state of 0.85 or more), which is not over-saturation, is referred to as near-saturation. The demand rate is less than one.

“Demand rate”: The demand rate may be calculated in three stages, for each lane, for each signal indication, or for the entire intersection. The demand rate for a lane is a value obtained by dividing the traffic demand of a target lane through which a vehicle can pass in a certain signal indication by the saturation traffic flow rate of the lane. The demand rate for the signal indication is the highest value among the demand rates of the lanes to which the right-of-way is given in each signal indication. The demand rate for the intersection is the sum of the demand rates of the signal indication. That is, the effective green signal time is a ratio of the minimum effective green signal time required to handle traffic demand flowing into the intersection from all directions to the total time.

The demand rate of the embodiment of the present disclosure may be any of the three stages described above. It is noted that, the demand rate may be referred to as a “saturation degree”. Since one cycle of a signal includes an effective green signal time and a loss time, when the demand rate of the intersection exceeds approximately 0.9, the traffic capacity is often insufficient for the traffic demand in the designed signal indication. It is noted that, since the loss time length varies depending on the signal indication scheme and the geometric structure, the value of the demand rate serving as a criterion for determining the traffic capacity may vary.

### [Overall Configuration of System]

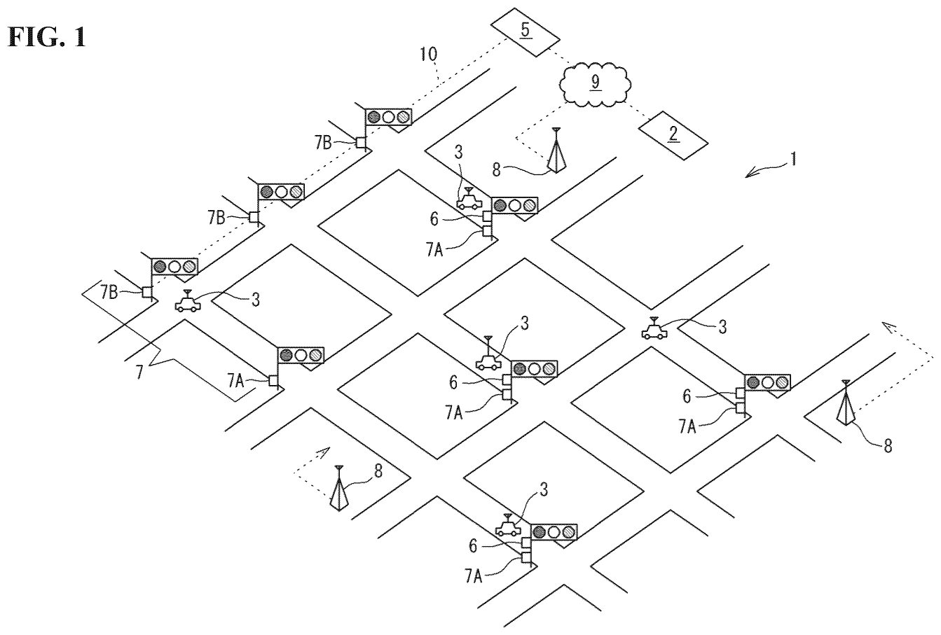

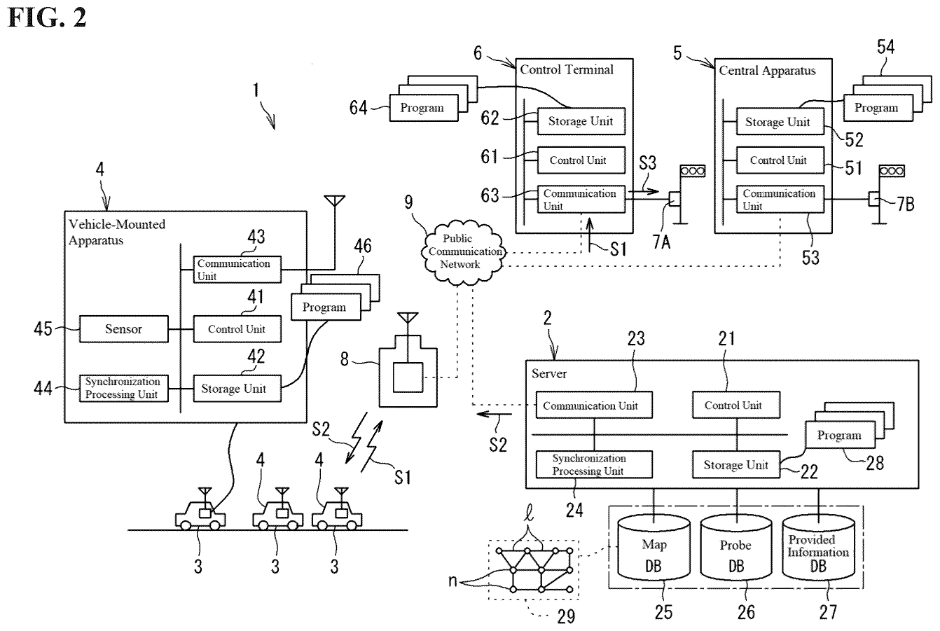

FIG. 1 is a diagram showing the overall configuration of a traffic signal control system 1 according to an embodiment. FIG. 2 is a block diagram of a server 2, a vehicle-mounted apparatus 4 of a probe vehicle 3, a central apparatus 5, and a control terminal 6 included in traffic signal control system 1.

As shown in FIG. 1 and FIG. 2, traffic signal control system 1 includes server 2 which is an information processing apparatus installed in a data center or the like, vehicle-mounted apparatus 4 mounted on probe vehicle 3, central apparatus 5 of a traffic control system center, traffic signal controllers 7 installed at respective intersections, and control terminal 6 which is an information processing apparatus connected to a traffic signal controller 7A which is a part of the plurality of traffic signal controllers 7.

In traffic signal control system 1 of the embodiment, server 2 collects probe information including a vehicle position and its passage time from probe vehicle 3 and transmits the probe information to control terminal 6. Further, control terminal 6 determines a signal control parameter such as a split suitable at the present time at every predetermined period based on the probe information received from server 2, and provides the determined signal control parameter to traffic signal controller 7A.

The operation entity of server 2 is not particularly limited. For example, the operation entity of server 2 may be a manufacturer of vehicle 3, an IT company that performs various information providing businesses, or the like, or may be a public business operator that takes charge of a traffic control system that operates central apparatus 5. The operation format of server 2 may be either an on-premise server or a cloud server.

Vehicle-mounted apparatus 4 of probe vehicle 3 can perform wireless communication with wireless base stations 8 (for example, mobile base stations) in various places. Wireless base station 8 can communicate with server 2 via a public communication network 9 including a core network of mobile communication, the Internet, and the like. Vehicle-mounted apparatus 4 of vehicle 3 wirelessly transmits a communication packet addressed to server 2 including uplink data to wireless base station 8. The uplink data includes a probe information S1 sensed by probe vehicle 3, and the like.

Server 2 transmits a communication packet addressed to vehicle-mounted apparatus 4 including downlink data to public communication network 9. The downlink data includes a provided information S2 for the vehicle useful for supporting the vehicle driving.

### [Configuration of Server]

As shown in FIG. 2, server 2 includes a control unit 21, a storage unit 22, a communication unit 23, a synchronization processing unit 24, and a plurality of types of databases (DBs) 25 to 27. The databases 25 to 27 are electronic data constructed in a predetermined data array in storage unit 22. A part or all of the databases 25 to 27 may be constructed in an external storage device (not shown) connected to server 2.

Control unit 21 is an operation processing apparatus including a Central Processing Unit (CPU), a Random Access Memory (RAM), and the like. Control unit 21 may include an integrated circuit such as a Field-Programmable Gate Array (FPGA). Control unit 21 reads a computer program 28 stored in storage unit 22 into the main memory (RAM), and executes various kinds of information processing in accordance with program 28. This information processing includes processing for generating the predetermined provided information S2 from probe information S1.

Storage unit 22 is an auxiliary storage apparatus including a nonvolatile memory such as a Hard Disk Drive (HDD) and a Solid State Drive (SSD). Storage unit 22 may include a flash Read Only Memory (ROM), a Universal Serial Bus (USB) memory, an SD card, or the like.

Communication unit 23 is a communication interface capable of performing communication via public communication network 9. When communication unit 23 receives probe information S1, which is transmitted from vehicle-mounted apparatus 4, from wireless base station 8, it transfers the received probe information S1 to control unit 21. Control unit 21 records the received probe information S1 in probe database 26.

When receiving provided information S2 from control unit 21, communication unit 23 generates a communication packet addressed to vehicle-mounted apparatus 4 including the received provided information S2, and transmits the communication packet to wireless base station 8. When receiving probe information S1 from control unit 21, communication unit 23 generates a communication packet addressed to control terminal 6 including the received probe information S1, and transmits the communication packet to wireless base station 8.

The plurality of types of databases 25 to 27 include map database 25, probe database 26, and provided information database 27. A road map data 29 covering the whole country is recorded in map database 25. Road map data 29 includes intersection data and link data.

The “intersection data” is data in which an intersection ID assigned to the domestic intersection is associated with position information of the intersection. The “link data” is data in which the following information A to information D are associated with the link ID of a specific link assigned in correspondence with a domestic road.
Information A: position information of start point, end point, and interpolation point of specific link
Information B: azimuth information of start point, end point, and interpolation point of specific link
Information C: link ID connected to the start point of the specific link
Information D: link ID connected to the end point of the specific link

Road map data 29 configures a network corresponding to the actual road shape and the road traveling direction. Thus, road map data 29 is a network in which road sections between nodes representing intersections are connected by directed links 1 (lower case L). Specifically, the data structure of road map data 29 includes a directed graph in which a node n is set for each intersection and a pair of adjacent nodes n are connected by a pair of directed links 1 in opposite directions. Thus, in the case of a one-way road, only one way directed link 1 is connected to node n.

Probe information S1 received from the plurality of registered probe vehicles 3 is sequentially accumulated in probe database 26. Specifically, control unit 21 accumulates probe information S1 of a predetermined period (for example, one month) going back to the past from the present time in probe database 26. In response to a request from a predetermined control terminal 6, control unit 21 reads probe information S1 in a predetermined range and for a predetermined period including the intersection from probe database 26, and transmits the read probe information S1 to control terminal 6.

Provided information database 27 temporarily stores provided information S2 for the vehicle generated by control unit 21. Provided information S2 includes, for example, at least one of congestion information, position information of various facilities such as a parking lot, link travel time, and signal control of intersection. When a request is received from vehicle-mounted apparatus 4, control unit 21 reads provided information S2 of the request target from provided information database 27, and transmits provided information S2 to vehicle-mounted apparatus 4.

Synchronization processing unit 24 is a processing unit for achieving time synchronization with other communication nodes such as vehicle-mounted apparatus 4 and control terminal 6 according to a predetermined synchronization scheme. As the synchronization scheme of synchronization processing unit 24, for example, a synchronization scheme based on an output of a Global Navigation Satellite System (GNSS) receiver, a synchronization scheme using a communication frame such as a Network Time Protocol (NTP) and a Precision Time Protocol (PTP), or the like can be adopted.

### [Configuration of Vehicle-Mounted Apparatus]

As shown in FIG. 2, vehicle-mounted apparatus 4 includes a control unit 41, a storage unit 42, a communication unit 43, a synchronization processing unit 44, and a sensor 45. Among these, control unit 41, storage unit 42, and synchronization processing unit 44 are configured by one or a plurality of electronic control units (ECUs). The ECU, communication unit 43, and sensor 45 are communication nodes of an in-vehicle network using a predetermined communication cable as a communication path.

Control unit 41 is an operation processing apparatus including a CPU, a RAM, and the like. Control unit 41 may include an integrated circuit such as an FPGA. Storage unit 42 is an auxiliary storage apparatus including a nonvolatile memory such as an HDD and an SSD. Control unit 41 reads a computer program 46 stored in storage unit 42 into the main memory (RAM), and executes various kinds of information processing according to program 46. This information processing includes the generation and transmission processing of probe information S1 described above.

Communication unit 43 is a wireless communication device such as a gateway constantly mounted on vehicle 3, or a communication terminal (for example, a smartphone, a tablet computer, or a notebook personal computer) temporarily mounted on vehicle 3.

Sensor 45 includes a position sensor that measures the current position of the own vehicle, a speed sensor that measures the speed of the own vehicle, and a directional sensor that detects the current direction of the own vehicle. The position sensor is, for example, a GNSS receiver, and measures the current position of the vehicle in substantially real time. The speed sensor is, for example, an MR sensor that generates a pulse in response to the rotation of a gear, and measures the current speed of the vehicle in substantially real time. The directional sensor is formed of, for example, a gyro sensor, and measures the current direction of the own vehicle in substantially real time.

Synchronization processing unit 44 is a processing unit for performing time synchronization with other communication nodes such as server 2 and control terminal 6 according to a predetermined synchronization scheme. Control unit 41 determines the traveling time (current time corresponding to the current position of probe vehicle 3) to be included in probe information S1 in accordance with the local time generated by synchronization processing unit 44. As the synchronization scheme of synchronization processing unit 44, for example, a synchronization scheme based on an output of a GNSS receiver, a synchronization scheme using a communication frame such as NTP and PTP, or the like may be adopted.

### [Configuration of Central Apparatus]

As shown in FIG. 2, central apparatus 5 is a server computer for controlling traffic signal controllers 7 of a plurality of intersections included in the traffic control system area. Central apparatus 5 includes a control unit 51, a storage unit 52, and a communication unit 53.

Control unit 51 is an operation processing apparatus including a CPU and a RAM. Control unit 51 reads a computer program 54 stored in storage unit 52 and performs various kinds of information processing according to program 54.

Storage unit 52 is an auxiliary storage apparatus including at least one nonvolatile memory (recording medium) of an HDD and an SSD. Storage unit 52 may include a flash ROM, a USB memory, an SD card, or the like. Computer program 54 of central apparatus 5 includes a program for causing the CPU of control unit 51 to execute remote control (traffic adaptation control) of traffic signal controller 7.

Traffic signal controllers 7 in the traffic control system area include first controller 7A of a locational control system which operates independently (stand-alone) and a second controller 7B which is a control target of remote control by central apparatus 5. Specifically, traffic signal controllers 7 include two types of traffic signal controllers, that is, first controller 7A and second controller 7B.

First controller 7A: traffic signal controller that is not subjected to remote control (system control, surface control, and the like) by central apparatus 5 and independently performs locational control (periodic control and the like) for determining a signal light color. Second controller 7B: traffic signal controller which is subjected to remote control (system control, surface control, and the like) by central apparatus 5.

When the signal control parameter is generated by the remote control, control unit 51 generates a signal control command to be executed by second controller 6B which is a control target of the remote control. The signal control command is information regarding the light color switching timing of the signal light corresponding to the newly generated signal control parameter, and is generated for each control period (for example, 1.0 to 2.5 minutes) of the remote control.

Communication unit 53 is a communication interface that can perform both communication with server 2 via public communication network 9 and communication with second controller 7B via dedicated communication line 10 (see FIG. 1). Communication unit 53 may be connected to server 2 via dedicated communication line 10. Communication unit 53 transmits the signal control command generated by control unit 51 for each control period of the signal control parameter to second controller 6B that is the target of the remote control.

### [Configuration of Control Terminal]

As shown in FIG. 2, control terminal 6 is a computer device including a control unit 61, a storage unit 62, and a communication unit 63. Specifically, control terminal 6 of the embodiment is a terminal device that determines a signal control parameter suitable at the present time based on probe information S1 received from server 2 and provides the determined signal control parameter to first controller 7A.

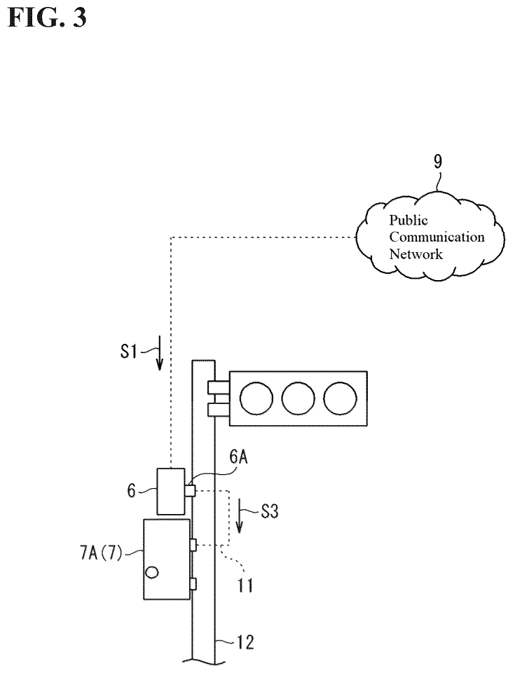

Control unit 61 is an operation processing apparatus including a CPU, a RAM, and the like. Control unit 61 may include an integrated circuit such as an FPGA. Control unit 61 reads a computer program 64 stored in storage unit 62 into the main memory (RAM), and executes various kinds of information processing in accordance with program 64. This information processing includes processing for generating a signal control parameter S3 (see FIG. 3) for first controller 7A from probe information 51.

Storage unit 62 is an auxiliary storage apparatus including a nonvolatile memory such as an HDD and an SSD. Storage unit 62 may include a flash ROM, a USB memory, an SD card, or the like.

Communication unit 63 is a communication interface that can perform both communication with server 2 via public communication network 9 and communication with first controller 7A via dedicated communication line 11 (see FIG. 3). Communication unit 63 may be an interface that is connected to public communication network 9 by wireless communication with wireless base station 8. Communication unit 63 transmits the signal control parameter such as the split generated by control unit 61 for each predetermined control period to first controller 7A which is standalone traffic signal controller 7.

FIG. 3 is an explanatory diagram showing an example of the installation state of control terminal 6. As shown in FIG. 3, control terminal 6 is fixed to, for example, a pole 12 on which first controller 7A is installed. Control terminal 6 is disposed in the vicinity of first controller 7A, for example, immediately above first controller 7A. Control terminal 6 has a communication port 6A and is connected to first controller 7A by dedicated communication line 11 connected to communication port 6A.

### [State Transition of Dynamic Control of Split]

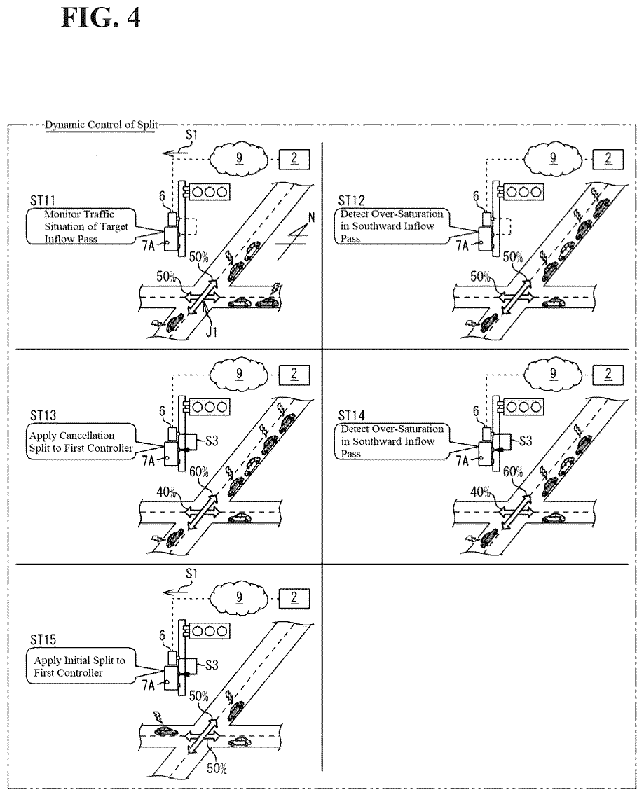

FIG. 4 is an explanatory diagram showing an example of state transition of dynamic control of split. In FIG. 4, first controller 7A is a controller that is installed at an intersection J1 where the north-south direction and the east-west direction intersect each other and performs periodic control (locational control). Further, it is assumed that the split currently applied at intersection J1 under the periodically control of first controller 7A (hereinafter referred to as the “initial split”) is 50% to 50%. It is noted that, in FIG. 4, the hatched vehicle is probe vehicle 3.

As shown in FIG. 4, the dynamic control of the split performed by control terminal 6 includes the following five statuses ST11 to ST15.
ST11: Monitoring of traffic situation
ST12: Detection of over-saturation
ST13: Control execution (application of cancellation split)
ST14: Detection of over-saturation relief
ST15: Control execution (cancellation of cancellation split)

The traffic situation monitoring ST11 is a status that monitors the traffic situations of all the inflow passes (eastward, westward, southward, and northward: hereinafter, referred to as “target inflow passes”) leading to intersection J1. Specifically, control terminal 6 calculates the traffic indicator of the target inflow pass every predetermined control period (for example, one minute) based on probe information S1 received from server 2. Control terminal 6 monitors the presence or absence of over-saturation in the target inflow pass in accordance with the calculated traffic indicator. The traffic indicator in this case is an indicator (hereinafter, also referred to as a “first traffic indicator”) that can determine the over-saturation of the inflow pass. For example, at least one of the average travel time of the wait-for-signal-to-change section, the delay time due to waiting for a wait-for-signal-to-change, the length of congestion due to waiting for a wait-for-signal-to-change, and the demand rate may be employed as the traffic indicator.

Detection of over-saturation ST12 is a status in a case where the occurrence of over-saturation is detected in any of the target inflow passes toward intersection J1. Specifically, detection of over-saturation ST12 is a status in a case where an inflow pass in which the first traffic indicator exceeds a predetermined threshold is detected. In detection of over-saturation ST12 in FIG. 4, a case where over-saturation occurs in the inflow pass directed to the southward is illustrated.

Control execution ST13 is a status in which a split for canceling the detected over-saturation (hereinafter, referred to as a “cancellation split”) is applied to first controller 7A. Specifically, control terminal 6 increases the initial split in the direction in which over-saturation is detected (north-south direction in the example of the figure) by a predetermined amount (for example, 10%), and decreases the initial split in the direction intersecting with the direction (east-west direction in the example of the figure) by a predetermined amount to calculate the cancellation split. Control terminal 6 transmits the calculated cancellation split (60% vs. 40% in the example of the figure) to first controller 7A.

The detection of over-saturation relief ST14 is a status of monitoring whether the detected over-saturation has turned into a tendency of the relieved by cancellation split. Specifically, control terminals 6 calculate the first traffic indicator of the target inflow pass at predetermined control intervals (for example, one minute) based on probe information S1 received from server 2, and monitor the presence or absence of the over-saturation in the target inflow pass is relieved depending on whether the time series variation of the calculated first traffic indicator has a tendency of declining.

The time series variation of the first traffic indicator can be determined by comparing the calculated value in the current control period related to the first traffic indicator with the calculated value in the previous control period or before the previous control period. Thus, when the first traffic indicator indicates, for example, any of the following time series variations, it can be determined that the target inflow pass has shifted to a tendency of the over-saturation to be relieved.
Time series variation 1: The current calculated value is smaller than the previous calculated value.
Time series variation 2: The current calculated value is smaller than the previous calculated value by an amount by a predetermined value or more.
Time series variation 3: The calculated value is smaller than the previous calculated value for N consecutive times (N is a natural number of two or more. For example, N=2).

Control execution ST15 is a status in which the cancellation split (60% vs. 40% in the example of the figure) is cancelled and the initial split (50% vs. 50% in the example of the figure) is applied to first controller 7A. Specifically, control terminal 6 calculates the first traffic indicator of the target inflow pass based on probe information S1 received from server 2, and determines the presence or absence of over-saturation again in the target inflow pass in accordance with the calculated first traffic indicator. When the over-saturation is cancelled, control terminal 6 cancels the cancellation split to return to the initial split, and transmits the initial split to first controller 7A.

### [Information Processing for Dynamic Control of Split]

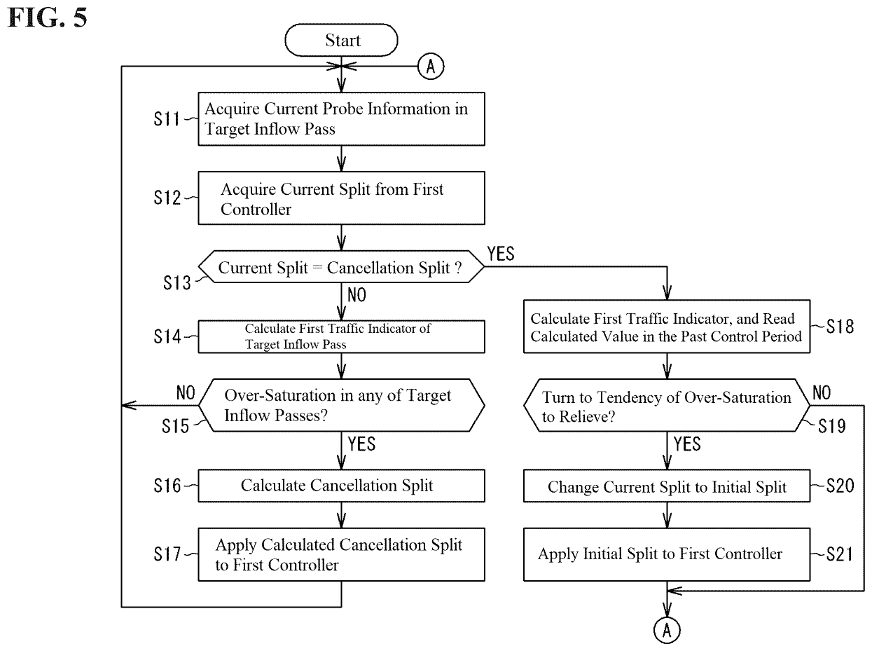

FIG. 5 is a flowchart showing an example of information processing for dynamic control of split. The information processing of FIG. 5 is executed by control unit 61 of control terminal 6 at every predetermined control period (for example, one minute).

As shown in FIG. 5, control unit 61 of control terminal 6 first acquires current probe information S1 in the target inflow pass of intersection J1 (step S11). Next, control unit 61 acquires the split at the present time (hereinafter referred to as “current split”) being applied at intersection J1 from first controller 7A (step S12). Next, control unit 61 determines whether the current split is equal to the cancellation split (step S13).

When the determined result of step S13 is negative, control unit 61 calculates the first traffic indicator of the target inflow pass (step S14). Next, control unit 61 determines whether over-saturation has occurred in any of the target inflow passes of intersection J1 in accordance with the calculated first traffic indicator (step S15). When the determined result of step S15 is negative, control unit 61 returns the process to before step S11.

When the determined result of step S15 is positive, control unit 61 calculates cancellation split for canceling over-saturation (step S16), and applies the calculated cancellation split to first controller 7A (step S17). Specifically, control unit 61 transmits the cancellation split to first controller 7A of intersection J1 connected to the own device.

When the determined result of step S13 is positive, control unit 61 calculates the first traffic indicator in the current control period and reads the calculated value of the first traffic indicator in the past control period from the memory (step S18). Specifically, the past control period is, for example, calculated values up to M (M is a natural number satisfying M≥2) periods before including the latest previous period, and control unit 61 reads at least one calculated value up to M periods before from the memory.

Next, control unit 61 determines whether the target inflow pass has turned to a tendency of the over-saturation to be relieved, referring to the time series variation of the first traffic indicator for each control period (step S19). Specifically, when at least one of the time series variation 1 to the time series variation 3 is detected, control unit 61 determines that the over-saturation of the target inflow pass has been changed to relieve. Further, when none of the time series variation 1 to the time series variation 3 is detected, control unit 61 determines that the over-saturation of the target inflow pass has not been changed to relieve (that is, the over-saturation continues).

When the determined result of step S19 is negative, control unit 61 returns the process to before step S11. When the determined result in step S19 is positive, the current split is changed to the initial split (step S20), and the changed initial split is applied to first controller 7A (step S21). Specifically, control unit 61 transmits the initial split to first controller 7A of intersection J1 connected to the own device.

### [State Transition of Dynamic Control of Offset]

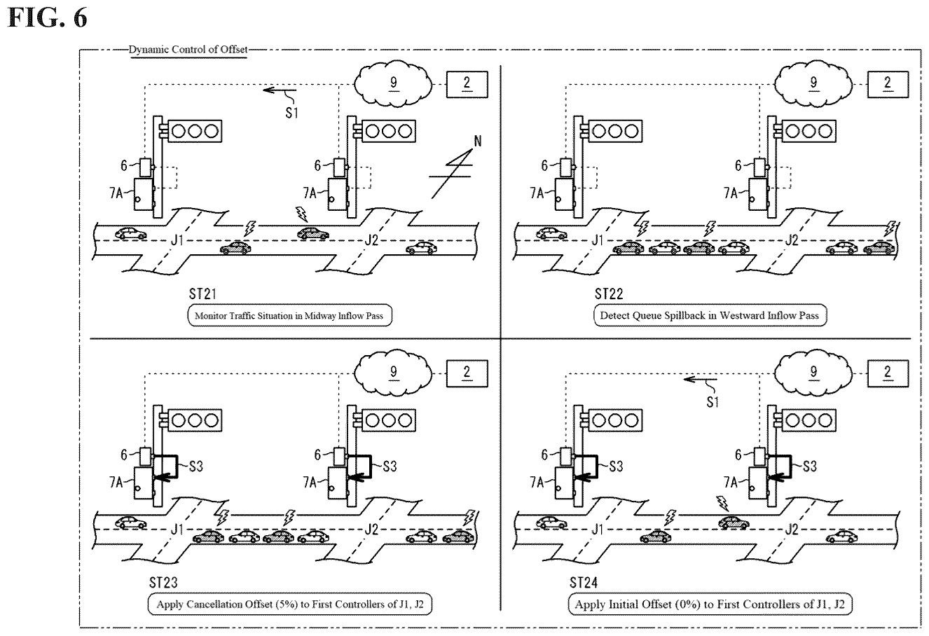

FIG. 6 is an explanatory diagram showing an example of a state transition of dynamic control of offset. In FIG. 6, intersections J1 and J2 are, for example, intersections adjacent to each other in the east-west direction, and control terminals 6 at intersections J1 and J2 can communicate with each other via public communications network 9. First controller 7A of each of intersections J1 and J2 is a controller that is installed at each of intersections J1 and J2 where roads in the north-south direction and the east-west direction intersect, and performs periodic control (locational control).

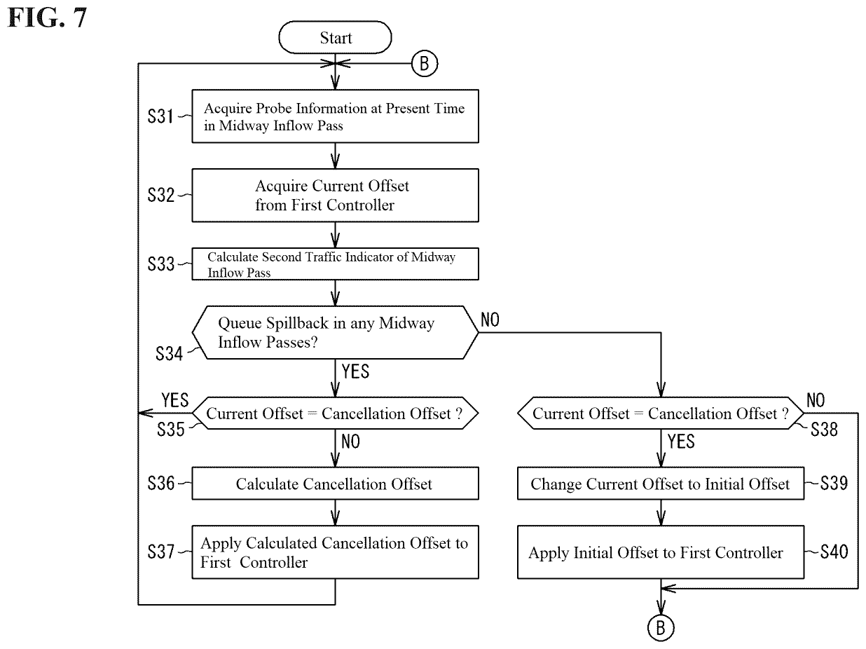

Further, first controller 7A of each of intersections J1 and J2 can execute the dynamic control of the offset of FIG. 6 and FIG. 7 described below in parallel with the dynamic control of the split of FIG. 4 and FIG. 5. Further, it is assumed that an offset (hereinafter, referred to as an “initial offset”) applied to each first controller 7A in the periodic control is 0% (no offset). In addition, the vehicles with diagonal lines in FIG. 6 represent probe vehicles 3.

As shown in FIG. 6, the dynamic control of the split performed by control terminal 6 includes the following four statuses ST21 to ST24.
ST21: Monitoring of traffic situation
ST22: Detection of queue spillback
ST23: Control execution (application of cancellation offset)
ST24: Cancellation of control (cancellation of cancellation offset)

Monitoring of traffic situation ST21 is a status for monitoring the traffic situation of a westward or eastward inflow pass between intersections J1 and J2 (hereinafter referred to as a “midway inflow pass”). Specifically, control terminal 6 of each of intersections J1 and J2 calculates a traffic indicator of the midway inflow pass for each predetermined control period (for example, one minute) based on probe information S1 received from server 2. Control terminal 6 monitors the presence or absence of a queue spillback in the midway inflow pass in accordance with the calculated traffic indicator.

The traffic indicator in this case is an indicator (hereinafter, also referred to as a “second traffic indicator”) capable of determining the queue spillback of the target inflow pass, and for example, a queue length (see Equation 3 described later) of the wait-for-signal-to-change section of the midway inflow pass, the end position of the wait-for-signal-to-change section in the midway inflow pass specified from the image data captured by probe vehicle 3, and the like can be adopted.

Detection of queue spillback ST22 is a status when the occurrence of a queue spillback is detected in the midway inflow pass between intersections J1 and J2. Specifically, detection of queue spillback ST22 is a status in the case where a traffic jam reaching intersection J2 on the upstream side is detected. In detection of queue spillback ST22 in FIG. 6, as an example, a case where a queue spillback occurs in the westward inflow pass is illustrated.

Control execution ST23 is a status in which an offset for canceling the detected queue spillback (hereinafter referred to as a “cancellation offset”) is applied to first controllers 7A of the two intersections J1 and J2. Specifically, control terminal 6 of each of intersections J1 and J2 calculates a cancellation offset (+5%) for delaying the cycle of intersection J2 on the upstream side in the direction in which the queue spillback is detected (westward in the example of the figure), and each control terminal 6 transmits the calculated cancellation offset to first controller 7A.

For example, when control terminal 6 of intersection J1 on the downstream side detects a queue spillback, control terminal 6 of intersection J2 on the upstream side is notified of the cancellation offset (+5%), and control terminal 6 of the upstream side may instruct first controller 7A of intersection J2 to apply the cancellation offset. On the contrary, when control terminal 6 of intersection J2 on the upstream side detects the queue spillback, control terminal 6 of the upstream side may instruct first controller 7A of intersection J2 connected to the own device to apply the cancellation offset (+5%).

Cancellation of control ST24 is a status in which the cancellation offset (+5% in the example of the figure) is cancelled and the initial offset (0% in the example of the figure) is applied to first controllers 7A of two intersections J1 and J2. Specifically, control terminal 6 of each of intersections J1 and J2 calculates the second traffic indicator of the midway inflow pass based on probe information S1 received from server 2, and determines again the presence or absence of the queue spillback in the midway inflow pass in accordance with the calculated second traffic indicator.

When the queue spillback is cancelled, control terminal 6 of each of intersections J1 and J2 cancels the cancellation offset to return to the initial offset, and transmits the initial offset to first controller 7A.

For example, when control terminal 6 of intersection J1 on the downstream side detects cancellation of queue spillback, control terminal 6 of intersection J2 on the upstream side is notified of initial offset (0%), and control terminal 6 of the upstream side may instruct first controller 7A of intersection J2 to set initial offset. On the contrary, when control terminal 6 of intersection J2 on the upstream side detects cancellation of queue spillback, control terminal 6 of the upstream side may instruct first controller 7A of intersection J2 connected to the own device to set the initial offset (0%).

### [Information Processing for Dynamic Control of Offset]

FIG. 7 is a flowchart showing an example of information processing for dynamic control of offset. The information processing of FIG. 7 is executed by control units 61 of control terminals 6 of intersections J1 and J2 at every predetermined control period (for example, one minute).

As shown in FIG. 7, control unit 61 of control terminal 6 first acquires the probe information at the present time in the midway inflow pass of intersections J1 and J2 (step S31). Next, control unit 61 acquires the offset at the present time being applied at each of intersections J1 and J2 (hereinafter referred to as the “current offset”) from first controller 7A at each of intersections J1 and J2 (step S32). Next, control unit 61 calculates the second traffic indicator of the midway inflow pass (step S33).

Next, control unit 61 determines whether a queue spillback has occurred in any of the midway inflow passes of intersections J1 and J2 in accordance with the calculated second traffic indicator (step S34). When the determined result of step S34 is positive, control unit 61 determines whether the current offset is the cancellation offset (step S35). When the determined result of step S35 is positive, control unit 61 returns the process to before step S31.

When the determined result of step S35 is negative, control unit 61 calculates a cancellation offset for canceling the queue spillback (step S36), and applies the calculated cancellation offset to first controller 7A (split S37). Specifically, when the own device is control terminal 6 corresponding to intersection J1 on the downstream side of the queue spillback, the own control terminal 6 notifies control terminal 6 of intersection J2 on the upstream side of the cancellation offset. Further, when the own device is control terminal 6 corresponding to intersection J2 on the upstream side of the queue spillback, the own control terminal 6 transmits the cancellation offset to first controller 7A of intersection J2 on the upstream side.

When the determined result of step S34 is negative, control unit 61 also determines whether the current offset is the cancellation offset (step S38). When the determined result of step S38 is negative, control unit 61 returns the process to before step S31.

When the determined result of step S38 is positive, control unit 61 changes the current split to the initial split (step S39), and applies the changed initial offset to first controller 7A (step S40). Specifically, when own apparatus is control terminal 6 corresponding to intersection J1 on the downstream side of the queue spillback, control unit 61 notifies the initial offset to control terminal 6 of intersection J2 on the upstream side. Specifically, when the own apparatus is control terminal 6 corresponding to intersection J2 on the upstream side of the queue spillback, control unit 61 transmits the initial offset to first controller 7A of intersection J2 on the upstream side.

### [Traffic Indicator Usable for Determination of Over-Saturation]

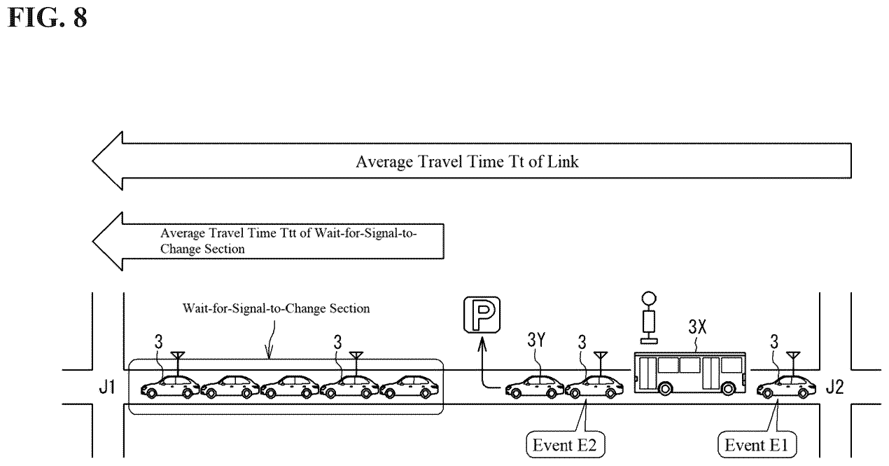

FIG. 8 is an explanatory diagram of an average travel time Ttt of the wait-for-signal-to-change section in the inflow pass, which is a kind of traffic indicator (first traffic indicator) usable for determining over-saturation. As shown in FIG. 8, stop events that can occur when probe vehicle 3 passes through the link from intersection J2 to next intersection J1 on the downstream side include, for example, following events E1 and E2, in addition to waiting for a wait-for-signal-to-change at intersection J1.
Event E1: Stop caused by becoming the following vehicle of bus 3X that stopped at the bus stop.
Event E2: Stop caused by becoming the following vehicle of another vehicle 3Y entering or exiting the parking lot.

When event E1 or E2 occurs in probe vehicle 3, the stop time of event E1 or E2 is included in an average travel time Tt of the link between intersection J1 and intersection J2, and thus the determination of whether the state is over-saturation is inaccurate.

Thus, as the traffic indicator used for the determination of over-saturation, average travel time Ttt of the wait-for-signal-to-change section, which is less affected by the stop time, may be used instead of average travel time Tt of the link, which may include the stop time of events E1 and E2 other than the signal waiting. Average travel time Ttt can be calculated by the following Equation 1.

$$[ Equation 1 ]$$

$$Ttt = {{\sum }_{i = 1}}^{I} \{ Li / ( Vi / 3.6 ) \} \qquad ( 1 )$$

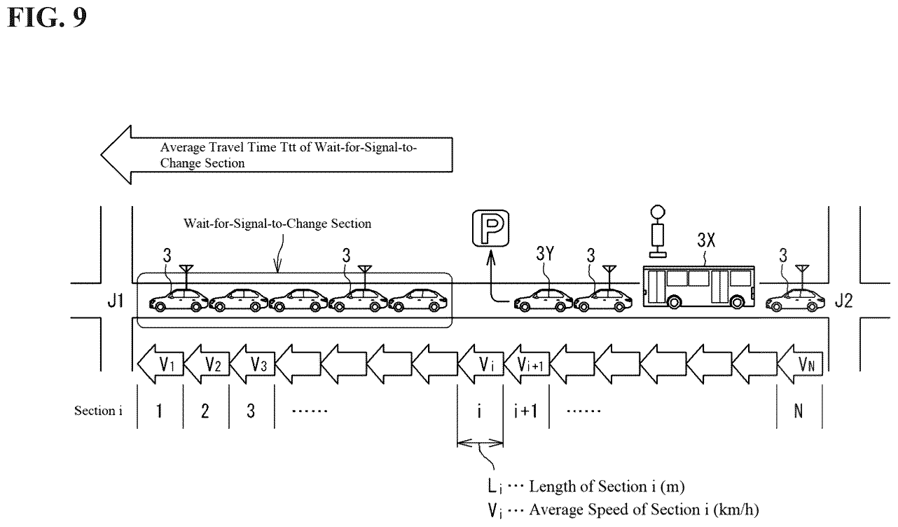

FIG. 9 is an explanatory diagram showing the definition of variables included in the calculation formula of average travel time Ttt of the wait-for-signal-to-change section. The variables include section i (i=1, 2 . . . N), the length Li (m) of section i, and an average speed Vi (km/h) of probe vehicle 3 passing through section i. Section i is composed of a plurality of small sections when the link between intersections J1 and J2 is divided by a predetermined number of divisions N. The length Li of section i (hereinafter, also referred to as “section length”) is a calculated value or a set value which is sufficiently shorter than a link length L between intersections J1 and J2.

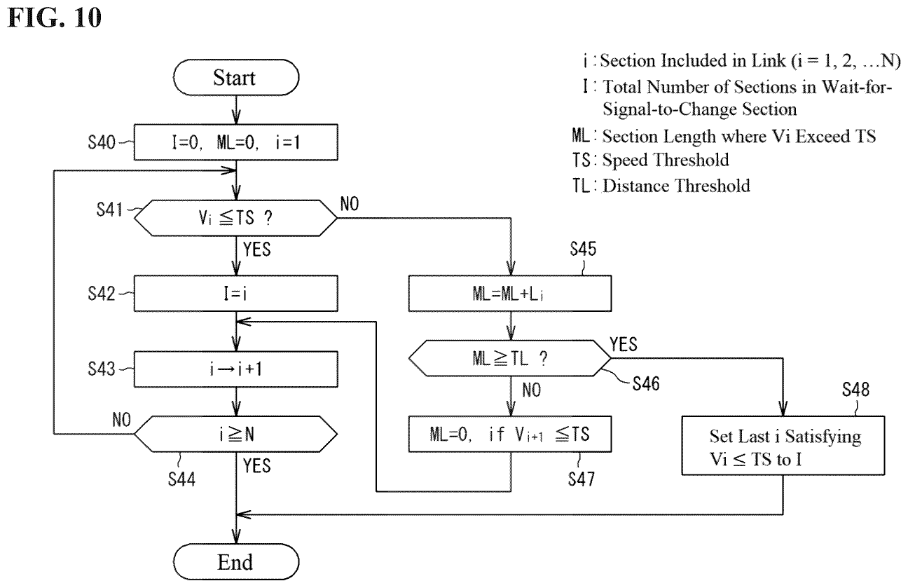

The average speed Vi of section i (hereinafter, also referred to as “section speed”) is the average speed of probe vehicles 3 calculated from the positions and times of the plurality of probe information S1, and is calculated by dividing the total value of the passing speeds of the plurality of probe vehicles 3 in section i by the number of probe vehicles 3. A total number of sections I corresponds to the identification number of section i positioned at the most upstream of the wait-for-signal-to-change section in the inflow pass toward intersection J1 to be controlled. It is noted that, the calculation processing of the total number of sections I (see FIG. 10) will be described in detail later.

When average travel time Ttt of the wait-for-signal-to-change section is adopted as the traffic indicator used for determining over-saturation, it is considered that the determination of over-saturation is made when average travel time Ttt is equal to or greater than a predetermined time threshold TH1 (for example, red signal time R of intersection J1), and the determination of non-saturated is made when average travel time Ttt is less than time threshold TH1.

As the traffic indicator used for the determination of the over-saturation, a delay time day per vehicle due to the signal waiting in the wait-for-signal-to-change section (hereinafter, abbreviated as “delay time day”) defined by the following Equation 2 may be used.

$$[ Equation 2 ]$$

$$dav = Ttt - {{\sum }^{I}}_{i = 1} \{ Li / ( Ve / 3.6 ) \} \qquad ( 2 )$$

As shown in Equation 2, the delay time day is a time obtained by subtracting the travel time (=Σ(Li/(Ve/3.6)) in a case where the vehicle travels at an assumed speed Ve in the wait-for-signal-to-change section (from section 1 to section I) without waiting for a traffic signal from average travel time Ttt of the wait-for-signal-to-change section.

When the delay time day is adopted as the first traffic indicator used for the determination of over-saturation, it is considered that the determination of over-saturation is made when the delay time day is equal to or greater than a predetermined time threshold TH2 (for example, ½ of red signal time R of intersection J1), and the determination of non-saturated is made when the delay time day is less than time threshold TH2.

As the first traffic indicator used for the determination of the over-saturation, a queue length Qu of the wait-for-signal-to-change section (hereinafter, abbreviated as “queue length Qu”) defined by the following Equation 3 may be used. This is because the total number of sections I is an identification number that can be regarded as the most upstream end (end) of the wait-for-signal-to-change section.

$$[ Equation 3 ]$$

$$Qu = {{\sum }^{I}}_{i = 1} Li \qquad ( 3 )$$

When queue length Qu is adopted as the first traffic indicator for determining over-saturation, it is possible to determine that the traffic is over-saturated when queue length Qu is equal to or greater than a predetermined distance threshold TH3 (for example, ½ of the link length between J1 and J2), and determine that the traffic is non-saturated when queue length Qu is less than distance threshold TH3. It is noted that, queue length Qu may be adopted as a second traffic indicator for determining the queue spillback of the midway inflow pass between intersections J1 and J2.

### [Calculation Processing of Total Number of Sections in Wait-for-Signal-to-Change Section]

FIG. 10 is a flowchart showing an example of the calculation processing of the total number of sections I in the wait-for-signal-to-change section, which is executed by control unit 61 of control terminal 6. In FIG. 10, “ML” is a variable representing a section length at which a section speed Vi exceeds a speed threshold TS. “TS” is the speed threshold and “TL” is a distance threshold.

Speed threshold TS is an estimated value of the average speed of the vehicle when the vehicle stops before intersection J1 to wait for a traffic signal to change. Speed threshold TS is a set value determined according to the number of section lengths Li, and is assumed that, in this case, TS=25 km/hour. Distance threshold TL is an estimated value of a cruising distance in a case where the vehicle traveling at the average speed exceeding speed threshold TS continues traveling without the intention of stopping. A distance threshold TS is a set value determined according to the amount of speed threshold TS, and it is assumed that TL=100 m.

As shown in FIG. 10, control unit 61 of control terminal 6 first performs initial setting of variables (step S40). Specifically, control unit 61 sets the initial values of the total number of sections I, a section length ML, and section i to I=0, ML=0, and i=1, respectively.

Next, control unit 61 determines whether Vi≤TS is satisfied (step S41). When the determined result of step S41 is positive (when section speed Vi of section i under determination is equal to or less than speed threshold TS), control unit 61 sets I=i (step S42), and then increments section i (step S43).

Next, control unit 61 determines whether i≥N is satisfied (step S44). When the determined result of step S44 is positive, control unit 61 ends the processing. When the determined result of step S44 is negative, control unit 61 returns the processing to before step S41. By the loop including steps S41 to S44, a search processing is executed in which section i satisfying the speed condition in which section speed Vi is equal to or less than speed threshold TS is searched for in order from the downstream side of the inflow pass, and the section satisfying the speed condition is counted as section i included in the wait-for-signal-to-change section.

When the determined result of step S41 is negative (when section speed Vi of section i under determination exceeds speed threshold TS), control unit 61 adds a section length Li of section i under determination to a variable ML (step S45), and then determines whether ML≥TL is satisfied (step S46).

When the determined result of step S46 is negative (when variable ML is less than distance threshold TL), control unit 61 resets variable ML to zero on condition that Vi+1≤TS is satisfied (step S47), and returns the process to before step S43. Thus, when Vi+1>TS, the value of variable ML is not reset but maintained, and the process is returned to before step S43.

The reason why variable ML is reset to zero when Vi+1≤TS is satisfied is that it is clear that variable ML does not increase in next section i+1 when section speed Vi+1 of next section i+1 is equal to or less than speed threshold TS. When the determined result of step S46 is positive (when variable ML is equal to or greater than distance threshold TL), control unit 61 determines the number value of last section i satisfying Vi≤TS as the total number of sections I in the wait-for-signal-to-change section (step S48), and ends the processing.

[Calculation Example of Total number of sections in Wait-for-Signal-to-Change Section]

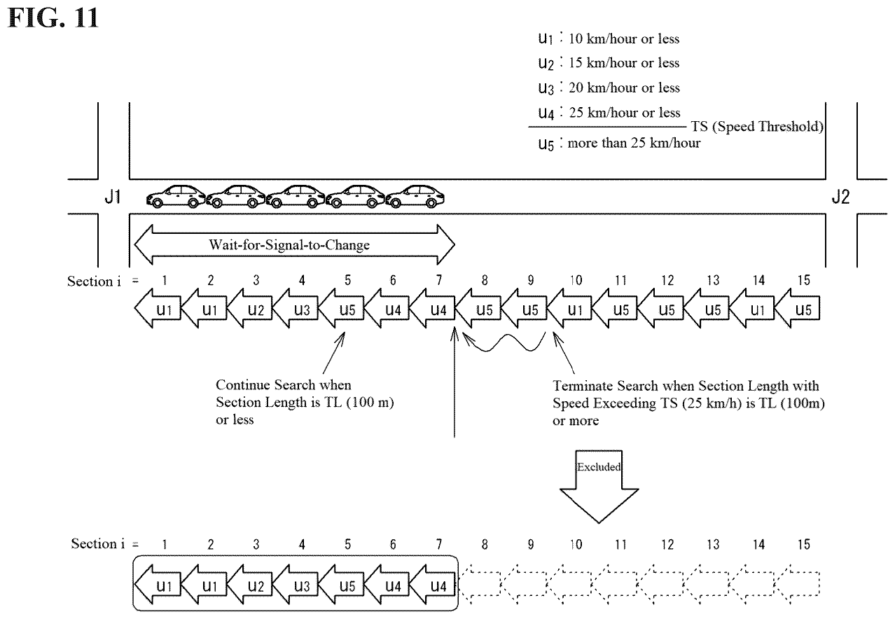

FIG. 11 is an explanatory diagram showing an example of actual calculation of the total number of sections I. In FIG. 11, the numerical values from “u1” to “u5” are the actual measurement values of section speed Vi obtained from the probe information of the plurality of probe vehicles 3, and are the following numerical values. Further, it is assumed that the number of divisions N of the link is 15, section length Li of each section i is all 50 m, TS is 25 km/hour, and TL is 100 m.
u1=Numerical value of 10 km/hour or less
u2=Numerical value of 15 km/hour or less
u3=Numerical value of 20 km/hour or less
u4=Numerical value of 25 km/hour or less
u5=Numerical values that exceed 25 km/hour

As shown in FIG. 11, section speeds V1, V2 (=u1) are equal to or less than speed threshold TS, and section speeds V3, V4 (=u3) are also equal to or less than speed threshold TS. Thus, the total number of sections I is counted up to “four” by the loop of steps S41 to S44 in FIG. 10. Since section speed V5 (=u5) exceeds speed threshold TS (NO in step S41 in FIG. 10), the search exits the loop of steps S41 to S44 in FIG. 10, and variable becomes ML=L5 (step S45 in FIG. 10).

Since the value of variable ML (L5=50 m) is less than distance threshold TL (=100 m) and a section speed V6 (=u4) of next section 6 is less than speed threshold TS (NO in step S46 of FIG. 10), the search of the total number of sections I is continued after resetting ML=0 (step S47 of FIG. 10). Thus, the total number of sections I is counted up to “five”.

Section speeds V6, V7 (=u4) are equal to or less than speed threshold TS. Thus, the total number of sections I is counted up to “seven” by the loop of steps S41 to S44 in FIG. 10. Since section speed V8 (=u5) exceeds speed threshold TS (NO in step ST41 in FIG. 10), the search exits the loop of steps S41 to S44 in FIG. 10, and variable becomes ML=L8 (step S45 in FIG. 10).

Since the value of variable ML (L8=50 m) is less than distance threshold TL (=100 m) and a section speed V9 (=u5) of next section 9 is equal to or more than speed threshold TS (NO in step S46 of FIG. 10), the search of the total number of sections I is continued while maintaining ML=L8 (step S47 of FIG. 10). Thus, the total number of sections I is counted up to “eight”.

Since section speed V9 (=u5) exceeds speed threshold TS (NO in step S41 in FIG. 10), the search exits the loop of steps S41 to S44 in FIG. 10, and variable becomes ML=L8+L9 (step S45 in FIG. 10).

Since the value of variable ML (L8+L9=100 m) is equal to or larger than distance threshold TL (=100 m) (YES in step S46 of FIG. 10), last section i (=7) satisfying Vi≤TS is determined as the value of the total number of sections I (step S48 of FIG. 10), and the processing is terminated. In this case, the most upstream end of last section i (=7) is regarded as the end of the wait-for-signal-to-change section. Thus, speeds Vi and section lengths Li of sections 8 to 15 on the upstream side of section 7 are excluded from the data for calculating average travel time Ttt.

### [Modification 1 of Dynamic Control of Split]

In the dynamic control of the split (FIG. 4 and FIG. 5), in addition to the target inflow pass being over-saturation, at least one inflow pass other than the target inflow pass not being over-saturation may be a condition for changing the target inflow pass to cancellation split. In this way, it is possible to handle the reduction of the over-saturation of each inflow pass fairly, in addition to the reduction of the split of the other inflow pass.

For the same reason, as the condition for changing the target inflow pass to the cancellation split, a condition that the target inflow pass is over-saturation and at least one inflow pass other than the target inflow pass is not near-saturation may be adopted.

### [Modification 2 of Dynamic Control of Split]

In the dynamic control of the split described above (FIG. 4 and FIG. 5), as the condition for changing the cancellation split to the initial split, the tendency of the over-saturation to be relieved (step S20 in FIG. 5) is adopted, but the conditions for changing to the initial split may also include the following conditions.
Condition 1: Any inflow pass other than the target inflow pass has turned into over-saturation.
Condition 2: The degree of over-saturation of any inflow pass other than the target inflow pass exceeds a predetermined allowable range.

When condition 1 is adopted, there is an advantage that the reduction of the over-saturation of each inflow pass can be executed fairly. Further, when condition 2 is adopted, there is an advantage that the reduction of the over-saturation of the target inflow pass can be given priority over the case of other inflow passes.

### [Modification 3 of Dynamic Control of Split]

In the dynamic control of the split (FIG. 4 and FIG. 5, modification 1 and modification 2), the traffic situation used for determining whether to change the split is “over-saturation”, but “near-saturation” may be adopted instead of the over-saturation. That is, the dynamic control of split is a control for applying cancellation split when a traffic situation of saturation of inflow pass is detected, and saturation of inflow pass may be either over-saturation or near-saturation.

Thus, in the case of using near-saturation, when near-saturation is detected in any of the plurality of inflow passes, the split of the target inflow pass in which near-saturation is detected may be changed from the initial split to the cancellation split. In this way, since the split can be increased before the over-saturation occurs, the over-saturation can be prevented or reduced. This is because near-saturation means a traffic situation with a lower degree of saturation than over-saturation.

As the first traffic indicator for detecting near-saturation, for example, “demand rate” may be adopted. In this case, for example, the inflow pass in which the demand rate is equal to or greater than a predetermined threshold (for example, 0.85) may be determined as the target inflow pass in which near-saturation is detected. Further, whether near-saturation has turned into a tendency of the relieved may be determined by whether the time series variation of the calculated value of the demand rate for each control period corresponds to any of the time series variation 1 to the time series variation 3 described above.

### Other Modifications

The above embodiments (including modifications) are illustrative in all respects and are not restrictive. The scope of the present invention includes all modifications within the scope equivalent to the configuration described in the claims. In the above embodiments, when the number of pieces of data of probe information S1 (the same as the number of probe vehicles 3) acquired in the current control period is not sufficient, the above dynamic control (FIG. 4 to FIG. 7) may be executed using preset complementary probe information.

The pieces of data of probe information S1 being insufficient means, for example, that the pieces of data acquired in the current control period is less than a predetermined number threshold (for example, 10). Further, as the complementary probe information, probe information prepared in advance for each inflow pass, probe information S1 acquired in the previous cycle, probe information S1 of the same day of the week in the past, or the like may be adopted.

In the above embodiments, at least one of the dynamic control of split (FIG. 4 and FIG. 5) and the dynamic control of offset (FIG. 6 and FIG. 7) may be executed by server 2 that collects probe information S1, instead of control terminal 6. In this case, control terminal 6 functions as a relay node that transfers the current split or the current offset received from first controller 7A to server 2 and transfers the cancellation split or the cancellation offset calculated by server 2 to first controller 7A.

As described above, the information processing apparatus that performs the split dynamic control (FIG. 4 and FIG. 5) and the offset dynamic control (FIG. 6 and FIG. 7) is not limited to control terminal 6 installed near first controller 7A, but may be server 2 that remotely controls first controller 7A.

### REFERENCE SIGNS LIST

1 traffic signal control system
2 server (information processing apparatus)
3 probe vehicle
4 vehicle-mounted apparatus
5 central apparatus
6 control terminal (information processing apparatus)
6A communication port
7 traffic signal controller
7A first controller
7B second controller
8 wireless base station
9 public communication network
10 communication line
11 communication line
12 pole
21 control unit
22 storage unit
23 communication unit (acquisition unit)
24 synchronization processing unit
25 map database
26 probe database
27 provided information database
28 computer program
29 road map data
41 control unit
42 storage unit
43 communication unit
44 synchronization processing unit
45 sensor
46 computer program
51 control unit
52 storage unit
53 communication unit
54 computer program
61 control unit
62 storage unit
63 communication unit (acquisition unit)
64 computer program
S1 probe information
S2 provided information
S3 signal control parameter (split, offset, etc.)

1. An information processing apparatus comprising:
an acquisition circuit configured to acquire probe information of a probe vehicle passing through an inflow pass leading to an intersection; and
a control circuit configured to execute dynamic control of determining, for each of predetermined control periods, a signal control parameter to be applied to the intersection, wherein
the intersection is an intersection not subjected to remote control by a central apparatus,
the signal control parameter includes a split to be applied to the intersection, and
the dynamic control includes split dynamic control of updating the split in accordance with a traffic indicator of the inflow pass, the traffic indicator being calculated from the probe information.

2. The information processing apparatus according to claim 1, wherein
the traffic indicator of the inflow pass includes a first traffic indicator from which saturation of the inflow pass is determinable, and
the control circuit is configured to increase a split of the inflow pass on a condition that saturation of the inflow pass has been detected in accordance with the first traffic indicator.

3. The information processing apparatus according to claim 2, wherein
the condition for increasing the split of the inflow pass further includes that any inflow pass other than the inflow pass is not saturated.

4. The information processing apparatus according to claim 3, wherein
the control circuit is configured to decrease the increased split of the inflow pass on a condition that a tendency of the detected saturation to be relieved has been detected.

5. The information processing apparatus according to claim 3, wherein
the control circuit is configured to decrease the increased split of the inflow pass on a condition that any inflow pass other than the inflow pass has turned to saturation.

6. The information processing apparatus according to claim 2, wherein
the saturation of the inflow pass is over-saturation of the inflow pass, and
the first traffic indicator is at least one of
an average travel time in a wait-for-signal-to-change section of the inflow pass,
a delay time per vehicle in the wait-for-signal-to-change section of the inflow pass, or
a queue length in the wait-for-signal-to-change section of the inflow pass.

7. The information processing apparatus according to claim 2, wherein
the saturation of the inflow pass is near-saturation of the inflow pass, and
the first traffic indicator is a demand rate of the inflow pass.

8. The information processing apparatus according to claim 1, wherein
the signal control parameter includes an offset to be applied to the intersection and an intersection on an upstream side of the intersection, and
the dynamic control includes offset dynamic control of updating the offset in accordance with the traffic indicator of the inflow pass, the traffic indicator being calculated from the probe information.

9. The information processing apparatus according to claim 8, wherein
the traffic indicator of the inflow pass includes a second traffic indicator from which whether the intersection on the upstream side has queue spillback is determinable, and
the control circuit is configured to adopt an offset of delaying a cycle of the intersection on the upstream side in response to detecting the queue spillback in accordance with the second traffic indicator.

10. The information processing apparatus according to claim 9, wherein
the second traffic indicator is at least one of
a queue length in a wait-for-signal-to-change section of the inflow pass or
an end position of the wait-for-signal-to-change section of the inflow pass, the end position being specified based on image data captured by the probe vehicle.

11. The information processing apparatus according to claim 1, wherein
the control circuit is configured to, when the probe information acquired in a current control period has an insufficient number of pieces of data, execute the dynamic control by using complementary probe information set in advance.

12. A control terminal connected to a traffic signal controller of an intersection not subjected to remote control by a central apparatus, the control terminal comprising:
a communication circuit configured to receive probe information of a probe vehicle passing through an inflow pass leading to the intersection; and
a control circuit configured to execute dynamic control of determining, for each of predetermined control periods, a signal control parameter to be applied to the intersection, wherein
the signal control parameter includes a split to be applied to the intersection, and
the dynamic control includes split dynamic control of updating the split in accordance with a traffic indicator of the inflow pass, the traffic indicator being calculated from the probe information.

13. An information processing method comprising:
acquiring probe information of a probe vehicle passing through an inflow pass leading to an intersection; and
executing dynamic control of determining, for each of predetermined control periods,
a signal control parameter to be applied to the intersection, wherein
the intersection is an intersection not subjected to remote control by a central apparatus,
the signal control parameter includes a split to be applied to the intersection, and
the dynamic control includes split dynamic control of updating the split in accordance with a traffic indicator of the inflow pass, the traffic indicator being calculated from the probe information.

14. A non-transitory computer-readable storage medium storing a computer program for causing a computer to function as an information processing apparatus comprising:
an acquisition circuit configured to acquire probe information of a probe vehicle passing through an inflow pass leading to an intersection; and
a control circuit configured to execute dynamic control of determining, for each of predetermined control periods, a signal control parameter to be applied to the intersection, wherein
the intersection is an intersection not subjected to remote control by a central apparatus,
the signal control parameter includes a split to be applied to the intersection, and
the dynamic control includes split dynamic control of updating the split in accordance with a traffic indicator of the inflow pass, the traffic indicator being calculated from the probe information.
